(19) United States
(12) Patent Application Publication
(10) Pub. No.: US 2021/0349993 A1
(43) Pub. Date: Nov. 11, 2021

(54) SYSTEM AND METHOD FOR DETECTING UNAUTHORIZED CONNECTED DEVICES IN A VEHICLE

(71) Applicant: AUTOVISOR PTE. LTD, Singapore (SG)

(72) Inventors: Dmitry Mikhailovich MIKHAILOV, Moscow (RU); Evgeny Valerievich GRUDOVICH, Minsk (BY); Vladimir Ivanovich RUTSKY, Minsk (BY); Alexandr Anatolievich PESOTSKY, Minsk (BY); Igor Fedorovich DUSHA, Moscow (RU)

(21) Appl. No.: 17/284,368

(22) PCT Filed: Oct. 10, 2019
(86) PCT No.: PCT/RU2019/050181

§ 371 Date: Apr. 9, 2021

(30) Foreign Application Priority Data
Oct. 11, 2018 (RU) 2018135956

(51) Int. Cl. G06F 21/55

(52) U.S. Cl. CPC G06F 21/552; G06F 2221/034

(57) ABSTRACT

The invention relates to the field of providing security to vehicles, specifically to a system and a method for detecting the connection of unauthorized devices. A system for detecting unauthorized connected devices in a vehicle comprises at least one electronic device of the vehicle, which is connected via an electrical bus to a module for detecting unauthorized devices consisting of a measurement unit, an analog-digital converter, a digital signal processing unit, a buffer unit and a comparator unit. A method for detecting unauthorized devices includes measuring the parameters of an electrical signal at a first moment and a second moment in time, with subsequent formation of an electrical signal spectrum. The electrical signal spectrum at the first moment in time is set as a threshold, on the basis of which a comparison is made with that received in the second time period. The accuracy of detecting unauthorized connected devices is increased.

The present invention relates to the vehicle safety field, namely, to the system and method for detecting the unauthorized device connections.

Modern vehicles feature an increasing number of new intelligent systems. Also, the existing systems (such as the systems of steering control, vehicle comfort, braking, cruise control, headlight control etc.) are being increasingly automated. The sensors, devices and systems that are part of the said systems exchange information through the electrical data exchange and control bus (hereinafter referred to as «bus» or «electrical bus»). The volume of the transmitted data grows which allows an intruder to obtain control over the vehicle and the bus itself if an unauthorized access to such a bus has been established. For example, an intruder can easily render the bus out of operation or initiate improper scenarios for the vehicle (headlights de-energization, airbags actuation, brakes deactivation etc.)

Such attacks become possible due to the electrical data exchange and control bus vulnerabilities. The strategies on the user protection and informing of such attacks, as well as on their suppression form part of the modern vehicle information security package.

The proposed invention allows determining and registering the devices installed on the electrical buses illegally which helps preventing various attacks.

A vehicle security system has been known from the prior art (see http://www.igla-systems.ru/katalog/immobilajzery/igla-pro), in the form of an immobilizer with digital LIN and CAN buses immobilization. Upon an unauthorized access, the engine is immobilized through the standard wiring of a vehicle, namely, through the CAN/LIN digital buses. The immobilizer sends a respective command after which the engine stops.

The described solution is intended only for solving the vehicle hijacking problem and doesn't guarantee the vehicle cyber security and, consequently, the human safety. An illegally installed device can be used to harm a driver, passengers or pedestrians (e.g., deactivation of the low-beam/long-distance light during the night-time driving, airbags actuation, brakes deactivation etc.)

A product of Argus (Israel) is also known (see https://argus-sec.com/argus-ecu-protection/) which provides the vehicle information network security by detecting attacks, suspicious activities and changes in the standard vehicle network behavior. When installed in a vehicle, the system is used for network activities monitoring and for the attack analysis and liquidation.

However, this system operates at the protocol level and is incapable of identifying unauthorized installed devices on the electrical bus. The threat can be identified only at the moment the command is executed. This solution cannot be considered a full-featured vehicle cyber security guarantor. More specifically, this solution cannot address all the attack algorithms and requires constant manufacturer support as related to algorithms improvement, including the individual device adaptation for each of the vehicle information systems.

The closest technical solution (chosen as the prototype) is the system and method for providing the vehicle electronic systems security described in the U.S. Pat. No. 9,881,165B2 patent, published on 30 Jan. 2018. This system includes a device. This device is installed between the data bus and the electronic control unit (ECU). The device contains the following functional units:
a message reception unit (used to monitor the messages sent between the bus and the electronic control unit (ECU));
a message analysis unit (used to identify the unauthorized commands based on the set rules);
a message transmission unit (used to forward legitimate commands to the electronic control unit (ECU)).

This system is a device intended for the implementation of some of the hardware firewall functions. Owing to its structure and purpose, this system is characterized by the disadvantages similar to those described above. More specifically:
an unauthorized action can be detected only at the moment the command is issued;
the device requires constant improvement of the algorithms and of the embedded software by the manufacturer; one system device can be used for providing the cyber security of only one electronic control unit (ECU);
the system doesn't allow detecting the unauthorized substitution of the data bus standard electronic devices, including the installation of new ones.

The object of the present invention is to provide for the unauthorized electrical bus devices identification and registration that would be as efficient and accurate as possible.

The present invention (and, consequently, the system) eliminates all the above disadvantages of the existing systems:
an unauthorized electrical bus device can be detected before it starts to operate on the bus;
the system allows detecting an unauthorized substitution of the existing vehicle electrical bus devices;
the system allows detecting the installation of new vehicle information bus devices;
the system doesn't require the ensuing works aimed at the operating algorithms improvement;
the system can be universally used for the information buses of any vehicle or manufacturer;
the system can be installed on the electrical buses of virtually any type used in the modern vehicles;
the system features the display facilities and information archiving facilities, as well as adjustment options.

The technical result of the invention is the improvement of the unauthorized connected devices detection accuracy.

On part of the system, the claimed technical result is achieved owing to the fact that the vehicle illegally connected devices detection system contains at least one electronic vehicle device connected through the electrical bus to an unauthorized devices detection module consisting of a measurement unit, an analog-to-digital converter, a digital signal processing unit, a buffer unit and a comparator unit wherein the measurement unit' and the analog-to-digital converter design allows them receiving the electrical signal parameters from the electrical bus during the first and second time periods, the digital signal processing unit performs signal processing and signal spectrum construction, the buffer unit is intended for storing the obtained signal data and the comparator unit is used for comparing the signal spectra obtained during the first and second time periods by the way of the electrical signal components analysis.

On part of the method, the claimed technical result is achieved owing to the fact that the method of the vehicle illegally connected devices detection includes the following:

obtaining of the electrical signal parameters from the electrical bus during the first- and second-time intervals,

processing and construction of the obtained signals spectra,

setting the signal obtained during the first time interval as the threshold signal,

comparing the combined signals obtained during the first and second time periods by the way of the electrical signal spectral components analysis.

The proposed invention is illustrated by the drawings:

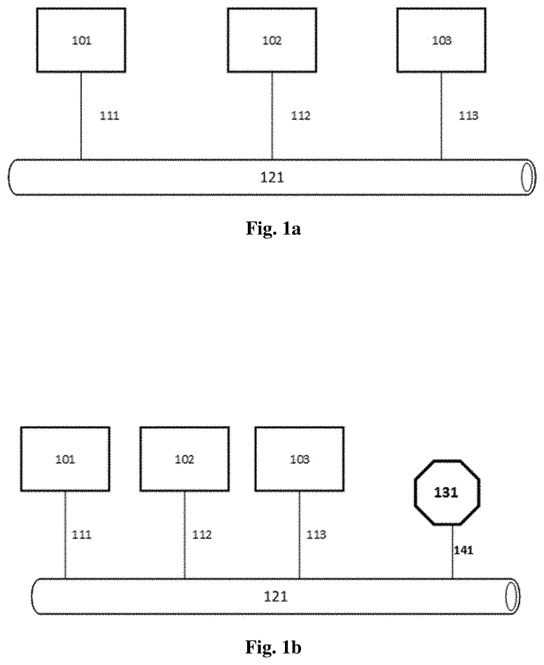

FIG. 1a illustrates the common topology of the vehicle electrical data exchange and control bus;

FIG. 1b shows an example of an unauthorized device connection to the vehicle electrical data exchange and control bus;

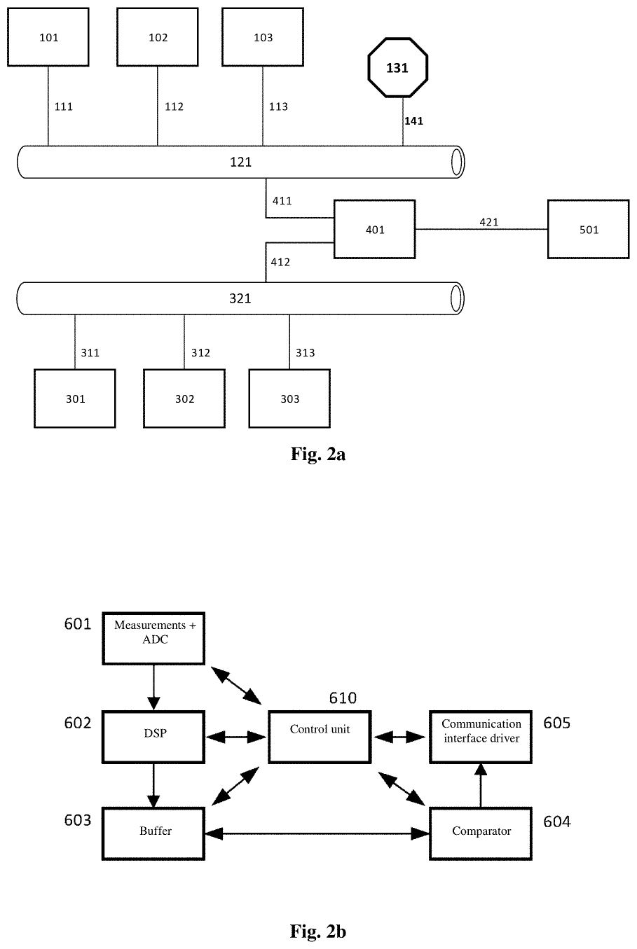

FIG. 2a presents the general view of the unauthorized connected devices detection system;

FIG. 2b illustrates the general functional diagram of the unauthorized devices detection module;

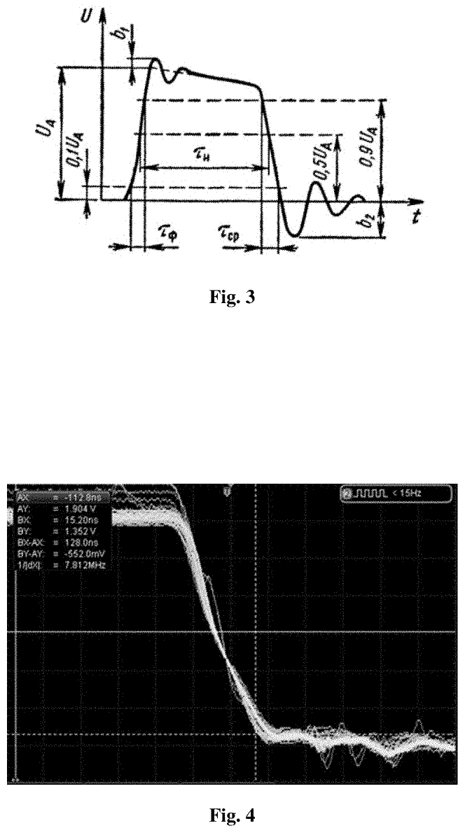

FIG. 3 demonstrates the time-response characteristic of a non-ideal distorted square pulse on the vehicle electrical bus;

FIG. 4 demonstrates the spectral characteristic of a signal with 2x modules connected to the electrical CAN bus;

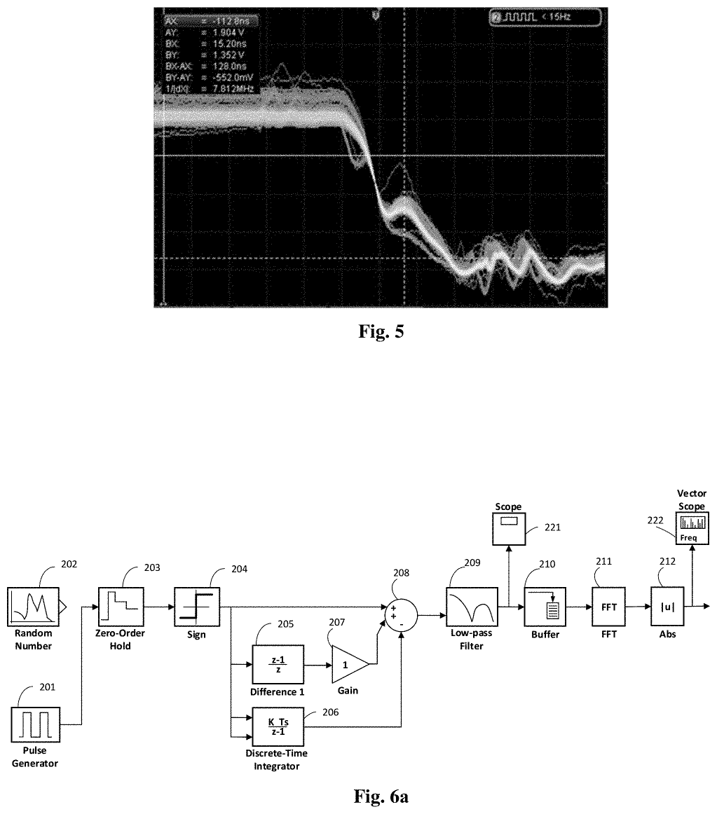

FIG. 5 demonstrates the spectral characteristic of a signal with 3x modules connected to the electrical CAN bus;

FIG. 6 illustrates the mathematical model created for modeling the signals of various nature and types on the vehicle electrical bus;

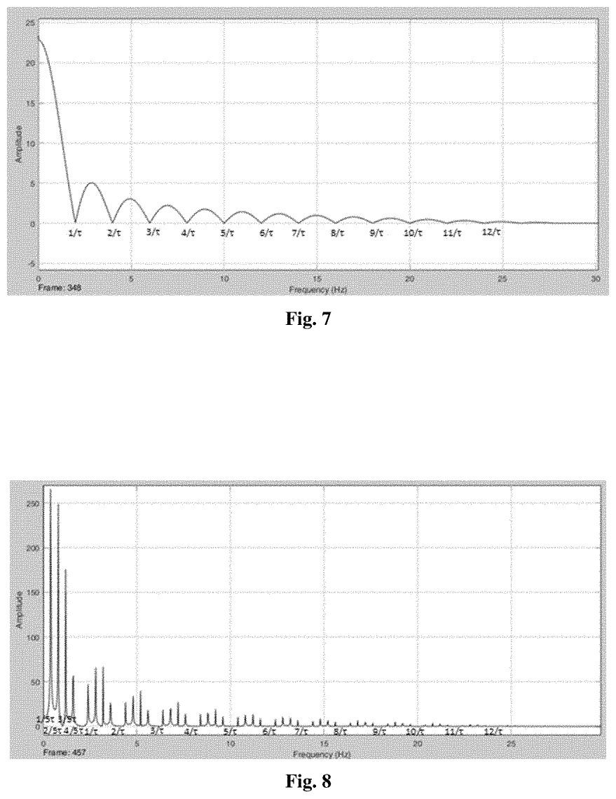

FIG. 7 shows the obtained type of the spectral characteristic for a single square pulse signal with the duration of τ;

FIG. 8 shows the obtained type of the spectral characteristic for a periodic square pulse signal with the on/off time ratio of 5 (T=5τ);

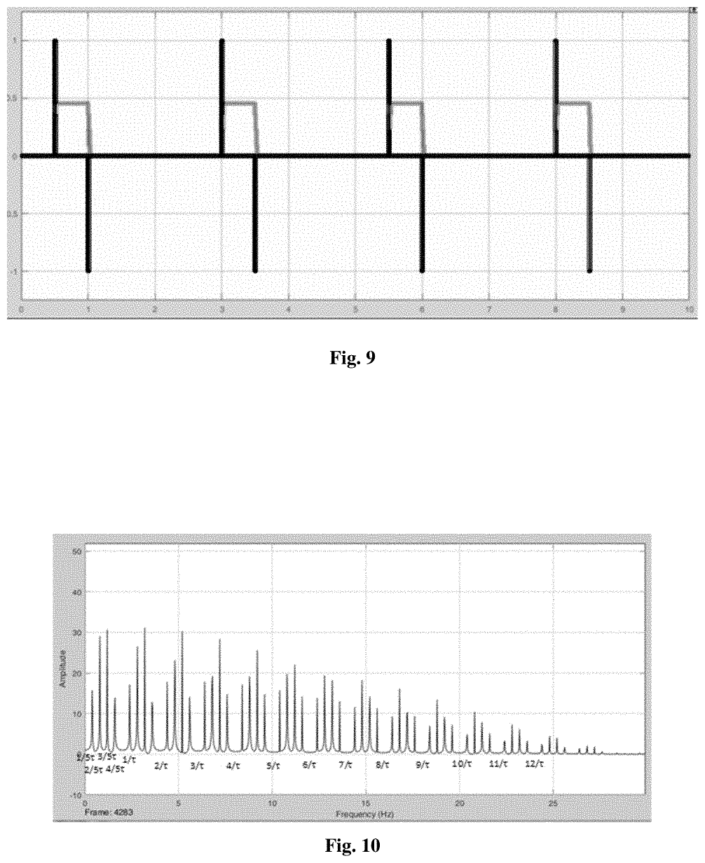

FIG. 9 shows the periodic signal type and its appearance after the differentiation (the heavy line);

FIG. 10 shows the obtained type of the spectral characteristic for the differentiated periodic square pulse signal with the on/off time ratio of 5 (T=5τ);

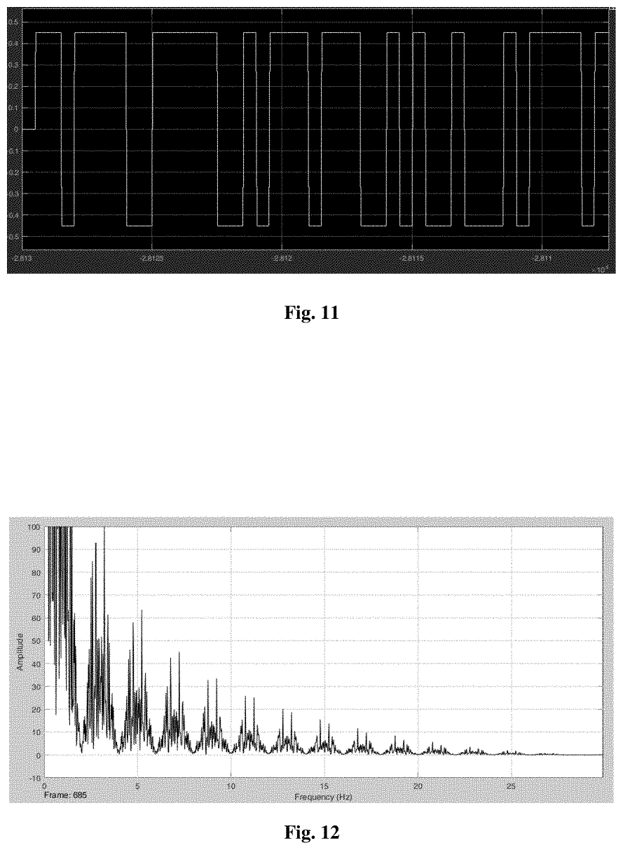

FIG. 11 illustrates the time-response characteristic of a digital data sequence on the vehicle electrical bus (an ideal model without added distortions);

FIG. 12 illustrates the spectral-response characteristic of a digital data sequence on the vehicle electrical bus (an ideal model);

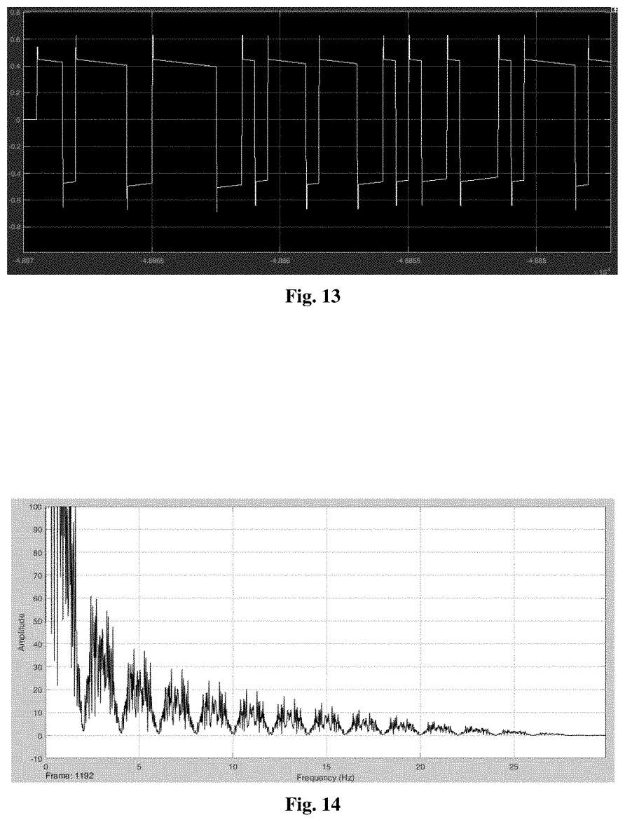

FIG. 13 illustrates the time-response characteristic of a digital data sequence on the vehicle electrical bus, with low-amplitude distortions;

FIG. 14 illustrates a type of the spectral characteristic of a digital data sequence on the vehicle electrical bus, with low amplitude distortions;

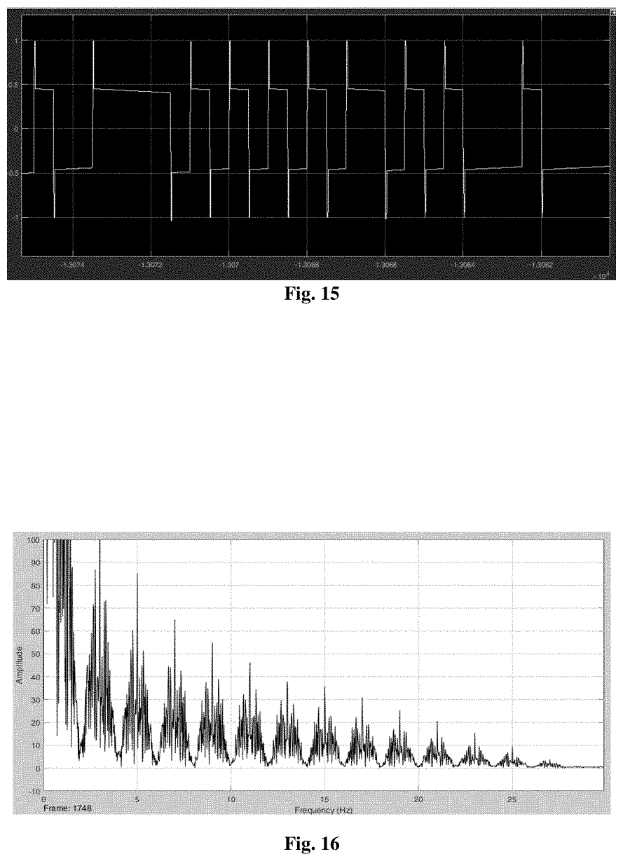

FIG. 15 illustrates the time-response characteristic of a digital data sequence on the vehicle electrical bus, with moderate amplitude distortions;

FIG. 16 illustrates a type of the spectral characteristic of a digital data sequence on the vehicle electrical bus, with moderate amplitude distortions;

FIG. 1a illustrates the common topology of a vehicle electrical data exchange and control bus; an electrical bus 121 of any type (CAN, LW, Ethernet etc.) can be used. The number of electronic devices 101, 102, 103 in the vehicle is not defined and can amount to dozens. Each device is connected to the bus by an individual electrical conductor 111, 112, 113. The information exchange between the electronic devices is effected according to certain rules (digital protocols). A vehicle can have several electrical buses; accordingly, the modules on each of the buses can intercommunicate based on their own standard (protocol).

The electrical data exchange and control bus of a vehicle constitutes electrical interconnections between a plurality of electronic devices (ECU). In this application a «vehicle electronic device» signifies any electronic device, e.g., an engine control device, a gearbox control device, a brake system control device (including ABS/ESC), a dashboard infotainment system device, a telemetry system device etc. Each of the said devices has its own functional purpose.

FIG. 1b shows a variant of an attack on the vehicle electrical data exchange and control bus effected by the unauthorized device 131 attachment. The presented arrangement demonstrates the vulnerability wherein the intruder has established the connection 141 to the electrical bus 121 to which several electronic devices 101, 102, 103 are connected. With such a connection the intruder has full access to the electrical bus and, accordingly, can control all the vehicle electronic devices.

FIG. 2a presents the general view of the unauthorized connected devices detection system. The system contains the electrical buses 121, 321 that are connected through the conductors 111, 112, 113, 311, 312, 313 to the vehicle electronic devices 101, 102, 103, 301, 302, 303. The default vehicle data bus configuration includes a plurality of devices that differ by type and purpose. The electronic components (through which the connection to the electrical bus is effected) are usually represented inside a module by driver integrated circuits. These integrated circuits have equivalent values of the output circuit physical parameters.

A driver integrated circuit is a digital-to-analog element that transforms a digital data bit sequence into an electrical signal with specified characteristics; such integrated circuit is also intended for impedance matching.

Each of the vehicle electrical buses is characterized by a number of physical parameters such as reactive impedance, active impedance, dominant and recessive bus state voltages, average and maximum consumption current, bus speed, pulse on/off time ratio etc. Each driver integrated circuit, when connected to the vehicle electrical data exchange and control bus, introduces changes into the bus electrical parameters.

To detect the connected unauthorized device 131 on the electrical bus, a spectral analysis method is used. This method provides a higher accuracy of the illegally connected devices detection as compared to the physical parameter's registration method (due to the digital signal processing algorithms use as opposed to the methods associated with the analog signal processing). This method provides for the registration taking place at the moment the messages are exchanged through the electrical bus (in the «active» bus state).

The illegally connected devices detection algorithms are implemented through the spectral analysis method, in a separate module 401. This module can be connected to one or several electrical buses 121, 321. The connection is effected by individual lines, with the conductors 411, 412.

The illegally connected devices detection method includes the obtaining of the electrical signal parameters during the first and second time periods. The first time period is usually the moment when the vehicle is bought, or when the vehicle is passing a technical inspection, or any other moment of time. The second time period is any moment of time set by the vehicle user or standing at a certain time interval (one day, one week, one month) from the first time period.

The system operates in three main stages:
measuring the electrical signal parameters in the first and second moments of time, with the subsequent electrical signal spectrum construction. In the process, the electrical signal spectrum obtained in the first moment of time is set as the threshold spectrum based on which the comparison with the spectrum obtained in the second moment of time is performed;
comparing the signal spectrum obtained in the second moment of time with the signal spectrum obtained in the first moment of time, for the detection of the devices installed on the vehicle electrical bus illegally;
presenting the corresponding information to the user.

The first two stages are effected in module 401. The third stage is implemented by the display module 501 (FIG. 2a).

FIG. 2b illustrates the general functional diagram of the unauthorized devices detection module. Module 401 consists of the following parts: measurement registration and analog-to-digital conversion (ADC) unit 601; digital signal processing (DSP) unit 602; buffer unit 603; comparator unit 604; communication interface driver unit 605; control unit 610. Depending on the module 401 design, the said units can be implemented both in the software and hardware form. The measurement and ADC module 601 registers the measurements with a set sampling frequency, converts the data into a digital form and sends it to the DSP unit 602. The DSP unit processes the current measurements, filters them and constructs a spectrum for the current measurement in the frequency domain. Further, the obtained data is saved in the buffer unit 603, in the respective memory cells corresponding to the performed measurement type (more specifically, to whether that was a measurement performed at the initial moment of time or a subsequent measurement). The comparator unit 604 compares the subsequent measurements with the measurement performed at the initial moment of time. All the transfer algorithms and the arbitration procedures are performed on the control unit 610 commands. The communication interface driver unit 605 is intended for interpreting the data using an appropriate standard or data protocol and for outputting the information into the communication channel. All of the module 401 units setup parameters can be adjusted.

Any device with a human-computer interface HMI (a smartphone, a mobile or personal computer, a vehicle dashboard infotainment system, a server etc.) can be used as the display module 501. The transferred information can be displayed on the screen, archived or used for further processing.

Any communication interface or protocol (Wi-Fi, Bluetooth, radio channel, wired interface (CAN, Ethernet, RS485) etc.) can be used as a data transmission channel linking the device 401 to the display module 501.

Hereinafter follows the description of the electrical bus spectral characteristics analysis method for identifying the unauthorized installed devices, as exemplified by the electrical bus reactive impedance analysis.

For example, increasing the electrical bus reactive impedance distorts the square shape of a signal. This is attributable to the growing transient processes influence. The nature of the transient processes in any circuit (in this case—in the electrical bus) depends on the integro-differential properties of the reactive impedance component. The differential properties of the electrical bus are the reason the square signal is distorted; peaks are added to the signal on its edges (the positive peak—on the front edge and the negative—on the rear). The electrical bus differential properties are affected mostly by the reactive impedance capacitive component.

Thus, the higher the capacitive component, the higher are the peak amplitudes on the pulse edges. Therefore, a direct relationship is observed between the number of the electronic devices (including physical driver integrated circuits) connected to the vehicle electrical bus and the waveform of the electrical signal during the data transfer process. More specifically, the more devices are connected, the higher is the peak amplitude on the edges. When the vehicle electronic devices are replaced or substituted for, the above parameters also change due to the inhomogeneity of the driver integrated circuit characteristics.

From the spectral analysis point of view, the increased peak amplitude signifies the redistribution of the signal energy from the lower frequency area of the spectrum into the higher frequency area. The vehicle electrical bus spectral analysis is performed to identify the changes of the total electrical bus reactive impedance values. Based on the measurement of the said values, the time-dependent trends construction and the comparison with the preset parameters, one can draw conclusions concerning the type and configuration of the loads, the number of devices installed on the electrical bus and the deviations from the constant values. The spectral analysis method can be used in the moment when the vehicle electrical bus is active, i.e., when the devices are exchanging data.

Inside the vehicle electrical bus, the data is sent in the form of digital sequences that are meander shaped (consist of consecutive square pulses) at signal level. If the electrical bus resistive parameters differ, the signal waveform gets distorted and becomes non-square-shaped.

FIG. 3 demonstrates the time-response characteristic of a non-ideal square pulse form, where [symbol] is the pulse length; τ_{ϕ} is the pulse edge length; τ_{CP} is the waveform tail length. Overshoots (b1) are formed at the front pulse edges and roll-offs (b2)—at the rear ones. The analysis of the overshoots and roll-offs duration and amplitude allows calculating the total electrical bus reactive impedance. To analyze the digital signal overshoots and roll-offs on the vehicle electrical bus in time domain, it is necessary to have an analog-to-digital converter (ADC) with high sampling frequency (>200 MHz) and, accordingly, a high-performance microprocessor.

In this solution, it is proposed to evaluate the signal timewise changes in spectral domain. This approach is used for the analysis of signals that are periodic in nature.

A digital signal in the vehicle electrical bus has a characteristic that is close to periodic; therefore, using a lower ADC sampling frequency (amounting to tens of MHz) it is possible to register the signal edge changes. For this, it is necessary to accumulate the readings in the course of time (in the first and second time period) and then to analyze them in the frequency domain. The signal spectrum analysis is about measuring and comparing the high frequency subspectrum amplitude values. The more the digital signal waveform is distorted, the higher is the high-frequency spectrum amplitude.

FIGS. 4 and 5 present two spectral signal characteristics in two different time periods. The first case illustrates the connection of 2 modules to the electrical CAN bus during the first time period, and the second—the connection of 3 modules during the second time period. When comparing the presented spectral characteristics, one can clearly see the waveform differences.

Let's use the mathematical model method to theoretically substantiate the above statements. An electrical signal model will be created using which signals of various nature will be modeled and an analysis of the obtained spectral characteristics will be performed.

FIG. 6 presents a mathematical model that can be used to model a signal on the vehicle electrical bus. Either pulse generator unit 201 or random signal generation unit 202 can be used as the model input action. Afterwards, the signal is fed to the analog-to-digital converter unit 203 and to the sign forming unit 204. To form an actual signal (more specifically, with the roll-offs and overshoots with various characteristics added), it is necessary to pass the signal through the differentiator unit 205, amplifier unit 207, integrator unit 206 and summing unit 208. To build the formed signal spectrum, it is necessary to digitally process the signal. For this purpose, we will use the low-pass filter (LPF) unit 209, the buffer unit 210, the fast Fourier transformation (FFT) unit 211 and the module calculator unit 212. To build the time-dependent amplitude graph, we will use the oscillograph 221. And to build the signal spectrum, we will use the oscillograph 222.

Since the electrical signal in the bus has the form of a periodic square pulse sequence, its spectrum waveform will be described by the following formula:

$$X ( m ) = \frac{Sin ( π m )}{π m}$$

where m is the number of the signal reading in the time domain when the discrete Fourier transformation is used;

X(m) is the signal spectrum

When analyzing the periodic square signal spectrum, we will use the following properties that are specific to it:
if τ is the square pulse length value, the spectrum lobes will be positioned within the 1/τ intervals. And in n/τ points the spectrum will assume zero value (n is a natural number) (see FIG. 7);
if we take the pulse period value as T, the spectrum readings will be positioned after every 1/T of the interval;

FIG. 8 shows the spectral characteristic of a periodic square pulse signal with the on/off time ratio of 5 (T=5τ). Using the properties described above, one can come to the conclusion that four frequency readings are located in each of the lobes within the frequency interval of (n/τ; (n+1)/τ), the same frequency readings being spaced 1/5τ frequency values apart.

FIG. 9 presents a periodic square signal time-response characteristic and a differentiated characteristic (a thickened line) with the on/off time ratio of 5 (T=5τ). The pulse arrays in the front and rear signal edge locations can be clearly seen.

When comparing the spectra of the periodic square signal and of its differentiated sequence, we can see that they match one another as far as the frequency sample locations are concerned, but vastly differ in their amplitude distribution. This is due to the fact that an additional pulse array is present on the front and on the rear edge. The bulk of the square periodic signal spectrum energy is concentrated in the first lobe, at the frequencies of (0;1/τ) (see FIG. 8).

The differentiated periodic signal spectrum, on the contrary, is characterized by more uniform energy distribution among the first lobes (see FIG. 10). This is due to the fact that an additional pulse array is present on the front and on the rear periodic signal edges. Taking into account the linear nature of the frequency Fourier transformation, the spectra of the square periodic signal and of its differentiated sequence are summed upon their addition; thus, the resulting spectrum will have escalated high-order harmonics relative the main lobe. Thus, the more the differentiating properties of the electrical bus are manifested (due to the reactive impedance capacitive component), the lower is the main lobe/side lobes ratio.

FIG. 11 illustrates the time-response characteristic of a digital data sequence on the vehicle electrical bus (an ideal model). These signals have the form of a sequence of square pulses that are characterized by random duration and period. They are changed in time with the discretization of Δ (the duration of one data bit). The spectral characteristic of such a signal has the form of the frequency readings superposition at the frequencies of 1/nΔ, where n is a natural number [2;10] (FIG. 12) and 11 is the number of bits with the maximum possible sequence without the bit stuffing (5 dominant and 5 recessive bits). The amplitude distribution of frequencies will tend to the square signal waveform with the minimums in n/Δ points. As has been shown before, when the differentiated component is added to a square periodic signal, the spectrum changes due to the main lobe energy redistribution into the grating lobes; the same trend is observed with the random square periodic signal duration and period values.

FIG. 13 shows the time-response characteristic of a digital data sequence on the electrical bus with the distortions in the form of differentiated and integrated low amplitude additions to the main signal. FIG. 14 shows the spectral characteristic of such a signal.

FIG. 15 shows a signal (a digital sequence) that has greater amplitude distortions. FIG. 16 shows the spectral characteristic of such a signal. When comparing two oscillograph records (FIGS. 13 and 15) and their spectral characteristics (FIGS. 14 and 16) one can come to the conclusion that there are differences related to the increased high-frequency component values at greater amplitude distortions.

The analysis of the electrical signal spectral characteristics is performed by the way of comparing the ratio between the main lobe energy and the cumulative side lobes energy of the spectrum, and by the way of monitoring the ratio changes in time. If the ratio changes upwards that means that a device has been disconnected from the data bus; if the ratio diminishes, a new device has been connected to the data bus. The said characteristic feature is also observed when the vehicle electronic module is replaced on the electrical bus, since the electrical characteristics of the driver integrated circuits differ.

1. The vehicle unauthorized connected devices detection system containing at least one vehicle electronic device connected through an electrical bus to the unauthorized connected devices detection module that consists of a measurement unit, an analog-to-digital converter, a digital signal processing unit, a buffer unit, a comparator unit, a control unit and a communication interface driver unit wherein the measurement unit and the analog-to-digital converter are designed so that they can receive the electrical bus electrical signal parameters during the first and second time periods, the digital signal processing unit performs signal processing and signal spectrum construction, the buffer unit is intended for storing the obtained signal data, the control unit executes all the transfer and arbitration algorithms by sending the appropriate commands, the communication interface driver unit interprets the data using an appropriate standard or data protocol and outputs the information into the communication channel, and the comparator unit compares the signal spectra obtained during the first and the second time periods by analyzing the electrical signal spectral components and detects the devices installed on the vehicle electrical bus illegally based on the comparison results for the signal spectra obtained during the first and the second time periods.

2. The system according to claim 1 wherein it is designed so that it can transform, digitize and process the electrical signal, as well as build time-frequency characteristic curves.

3. The system according to claim 1 wherein it is designed so that it can analyze the measured current electrical signal for its waveform deviations from the parameters set during the first time period.

4. The system according to claim 3 wherein the electrical signal waveform deviations are analyzed based on the front and rear electrical signal edges overshoot amplitude changes (the reactive impedance changes).

5. The system according to claim 1 wherein the analysis of the electrical signal spectral components consists of the amplitude changes determination or the detection of the new high-frequency spectrum components.

6. The method of the unauthorized connected vehicle devices detection implemented by the system according to claim 1 and including the following:
obtaining of the electrical signal parameters from the electrical bus during the first- and second-time intervals,
processing and construction of the obtained signals spectra
setting the signal obtained during the first-time interval as the threshold signal,
comparing of the combined signals obtained during the first- and second-time intervals by the way of the electrical signal spectral components analysis,
and the detection of the devices installed on the vehicle electrical bus unauthorized based on the comparison results for the signal spectra obtained during the first and the second time periods.
